(19) United States
(12) Patent Application Publication
(10) Pub. No.: US 2012/0062564 A1
(43) Pub. Date: Mar. 15, 2012

(54) MOBILE ELECTRONIC DEVICE, SCREEN CONTROL METHOD, AND STORAGE MEDIUM STORING SCREEN CONTROL PROGRAM

(75) Inventors: Tsuneo MIYASHITA, Yokohama-shi (JP); Tomohiro SUDOU, Yokohama-shi (JP)

(73) Assignee: KYOCERA CORPORATION, Kyoto (JP)

(21) Appl. No.: 13/233,145

(22) Filed: Sep. 15, 2011

(30) Foreign Application Priority Data
Sep. 15, 2010 (JP) 2010-207352
Sep. 15, 2010 (JP) 2010-207353
Sep. 14, 2011 (JP) 2011-200992

(51) Int. Cl. G06T 15/00; G06F 3/041

(52) U.S. Cl. 345/419; 345/173

(57) ABSTRACT

A mobile electronic device includes a first touch sensor on a first face of a housing, a second touch sensor on a second face of the housing different from the first face, a display unit provided on the first face of the housing, and a control unit. When a first touch on the first face is detected by the first touch sensor and a second touch on the second face is detected by the second touch sensor, the control unit selects an object displayed on the display unit based on the first touch on the first face and the second touch on the second face.

This application claims priority from Japanese Application No. 2010-207352, filed on Sep. 15, 2010, Japanese Patent Application No. 2010-207353, filed on Sep. 15, 2010, and Japanese Patent Application No. 2011-200992, filed on Sep. 14, 2011, the contents of which are incorporated by reference herein in their entirety.

### BACKGROUND

1. Technical Field

The present disclosure relates to a mobile electronic device, a screen control method, and a storage medium storing therein a screen control program.

2. Description of the Related Art

Recently, a touch panel is widely used in order to enable an intuitive operation and achieve a compact mobile electronic device without requiring a physically large area for an user interface, such as a keyboard. For example, Japanese Patent Application Laid-open No. 2009-164794 discloses a mobile electronic device provided with a touch panel that displays an icon on the touch panel and activates a function corresponding to the icon when the displayed icon is touched with a finger or the like.

The above-discussed mobile electronic device provided with the touch panel can respond to a comparatively small number of operations, such as an operation of a short touch on the icon (tap), an operation of a long touch on the icon (long tap), and an operation of dragging the icon along the touch panel with the finger kept touched on the icon (drag). With such a comparatively small number of operations, it is sometimes difficult to provide user-friendly operability.

### SUMMARY

According to an aspect, a mobile electronic device includes; a housing having a first face and a second face different from the first face; a first detector for detecting a first touch on the first face; a second detector for detecting a second touch on the second face; a display unit provided on the first face of the housing; and a control unit. The control unit selects an object displayed on the display unit, based on a first position of the first touch detected on the first face and a second position of the second touch detected on the second face.

According to another aspect, a screen control method is executed by a mobile electronic device that includes a housing, a first detector that detects a touch on a first face of the housing, a second detector that detects a touch on a second face of the housing different from the first face, and a display unit provided on the first face of the housing. The screen control method includes: displaying an object on the display unit; detecting a first touch on the first face; detecting a second touch on the second face; and selecting the object displayed on the display unit based on a first position of the first touch detected on the first face and a second position of the second touch detected on the second face.

According to another aspect, a non-transitory storage medium stores a screen control program executed by a mobile electronic device including a housing, a first detector that detects a touch on a first face of the housing, a second detector that detects a touch on a second face of the housing different from the first face, and a display unit provided on the first face of the housing. The screen control program causes the mobile electronic device to execute displaying an object on the display unit; detecting a first touch on the first face; detecting a second touch on the second face; and selecting the object displayed on the display unit based on a first position of the first touch detected on the first face and a second position of the second touch detected on the second face.

### BRIEF DESCRIPTION OF THE DRAWINGS

FIG. 1 is a perspective view of a mobile phone terminal according to a first embodiment when viewed from its front face;

FIG. 2 is a perspective view of the mobile phone terminal according to the first embodiment when viewed from its back face;

FIG. 3 is a diagram for explaining detection of touch points by the mobile phone terminal according to the first embodiment;

FIG. 4 is a diagram for explaining a display of a pointer at a position corresponding to the touch point on the back face of the mobile phone terminal according to the first embodiment;

FIG. 5 is a diagram illustrating one example of screen control for setting a selection range of icons in the mobile phone terminal according to the first embodiment;

FIG. 6 is a diagram illustrating one example of screen control for changing the selection range of the icons in the mobile phone terminal according to the first embodiment;

FIG. 7 is a diagram illustrating one example of screen control for setting a selection range of a text in the mobile phone terminal according to the first embodiment;

FIG. 8 is a diagram illustrating one example of screen control for changing the selection range of the text in the mobile phone terminal according to the first embodiment;

FIG. 9 is a block diagram illustrating a schematic configuration of the mobile phone terminal according to the first embodiment;

FIG. 10 is a flowchart illustrating a processing procedure when the mobile phone terminal according to the first embodiment executes the screen control for operations of setting and changing a selection range;

FIG. 11 is a diagram illustrating one example of screen control for an operation of changing a display magnification of a screen of a mobile phone terminal according to a second embodiment;

FIG. 12 is a flowchart illustrating a processing procedure when the mobile phone terminal according to the second embodiment executes the screen control for the operation of changing the display magnification of the screen;

FIG. 13 is a diagram illustrating one example of screen control for an operation of rotating a three-dimensionally shaped icon in a mobile phone terminal according to a third embodiment;

FIG. 14 is a diagram illustrating one example of screen control for an operation of transforming a two-dimensionally shaped icon in a mobile phone terminal according to a third embodiment;

FIG. 15 is a diagram illustrating one example of screen control for an operation of pressing the three-dimensionally shaped icon in the mobile phone terminal according to the third embodiment;

FIG. 16 is a diagram illustrating one example of another screen control for the operation of pressing a three-dimensionally shaped icon in the mobile phone terminal according to the third embodiment;

FIG. 17 is a block diagram illustrating a schematic configuration of the mobile phone terminal according to the third embodiment;

FIG. 18 is a diagram illustrating one example of object data; and

FIG. 19 is a flowchart illustrating a processing procedure when the mobile phone terminal according to the third embodiment executes the screen control for the operation of rotating the icon and the operation of pressing the icon.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone terminal is used to explain as an example of the mobile electronic device, however, the present invention is not limited to mobile phone terminals. Therefore, the present invention can be applied to any type of devices provided with a touch panel, including but not limited to personal handyphone systems (PHS), personal digital assistants (PDA), portable navigation units, personal computers (including but not limited to tablet computers, netbooks etc.), media players, portable electronic reading devices, and gaming devices.

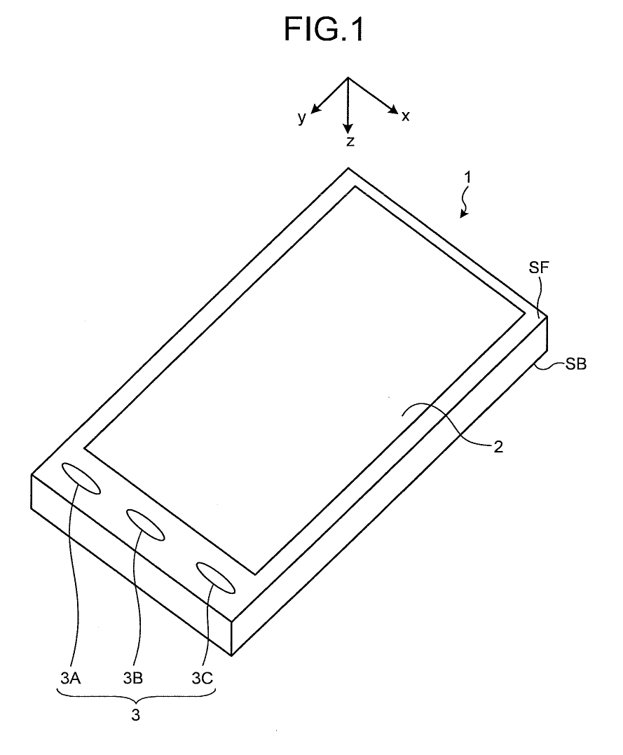

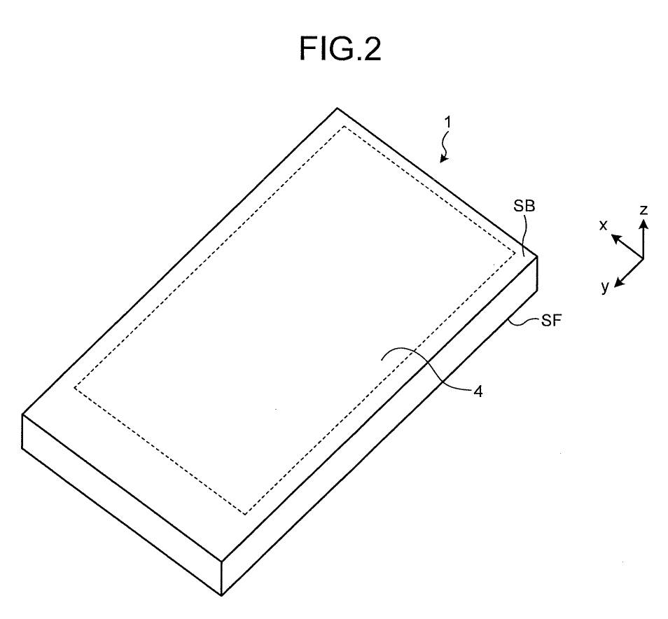

First, an overall configuration of a mobile phone terminal 1 according to a first embodiment will be explained below with reference to FIG. 1 and FIG. 2. FIG. 1 is a perspective view of the mobile phone terminal 1 when viewed from its front face, and FIG. 2 is a perspective view of the mobile phone terminal 1 when viewed from its back face. The mobile phone terminal 1 has a box-shaped housing with two major surfaces, i.e., a surface SF on the front face and a surface SB on the back face, which are larger than other surfaces of the housing. The mobile phone terminal 1 is provided with a touch panel 2 and an input unit 3 formed with a button 3A, a button 3B, and a button 3C on the surface SF. In addition, the mobile phone terminal 1 is provided with a touch sensor 4 on the surface SB.

The touch panel 2 displays characters, graphics, images, and so on, and detects various operations (gestures) performed by the user on the surface SF using his/her finger(s), a pen, a stylus or the like (in the description herein below, for the sake of simplicity, it is assumed that the user touches the touch panel 2 and the touch sensor 4 with his/her fingers). When any one of the buttons is pressed, the input unit 3 activates the function corresponding to the pressed button. The touch sensor 4 detects various operations performed by the user on the surface SB using his/her finger. The touch panel 2 and the touch sensor 4 are formed in substantially the same size, and are arranged so as to substantially overlap each other entirely in a Z-axis direction in FIG. 1 (i.e., in the direction perpendicular to the surface of the touch panel 2 or the touch sensor 4). The touch sensor 4 may be exposed to the outside or may be embedded in the surface SB.

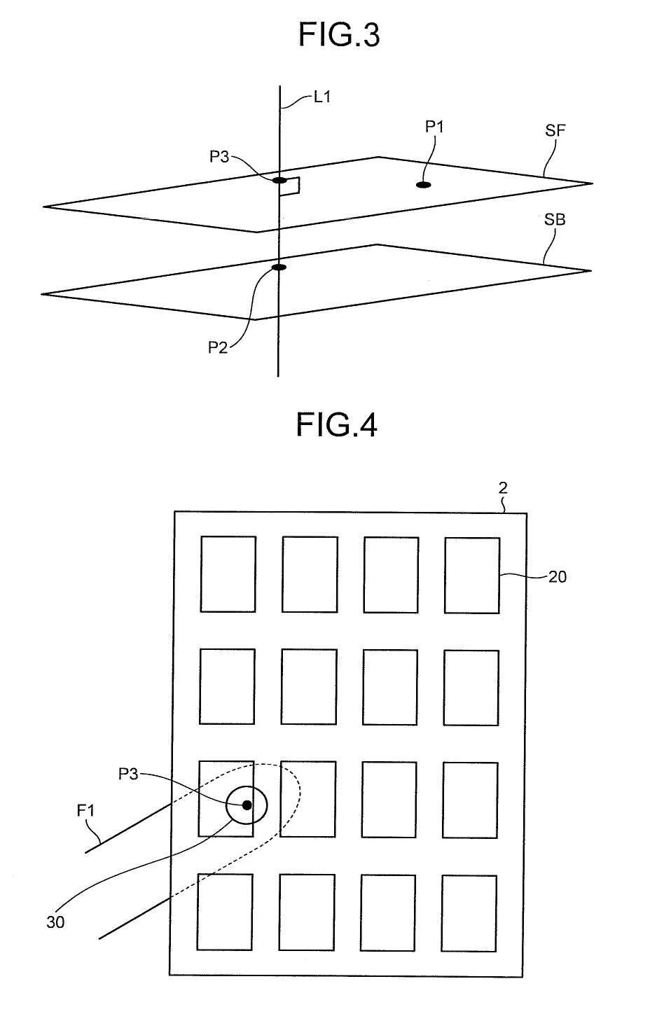

Detection of a touch point and display of a pointer by the mobile phone terminal 1 will be explained below with reference to FIG. 3 and FIG. 4. FIG. 3 is a diagram for explaining detection of touch points by the mobile phone terminal 1. FIG. 4 is a diagram for explaining a display of a pointer at a position corresponding to the touch point on the back face thereof.

As explained above, the mobile phone terminal 1 detects a touch with the finger on the surface SF being the front face using the touch panel 2, and detects a touch with the finger on the surface SB being the back face using the touch sensor 4. In the following explanation, a position where a touch with the finger on the surface SF is detected is called a first position P1, a position where a touch with the finger on the surface SB is detected is called a second position P2, and a position on the surface SF corresponding to the second position P2 is called a third position P3. As illustrated in FIG. 3, the third position P3 is the position where a line L1 passing the second position P2 and orthogonal to the surface SF intersects the surface SF, or the position on the surface SF which is closest to the second position P2.

As illustrated in FIG. 4, the mobile phone terminal 1 displays a pointer 30 indicating the third position P3 on the touch panel 2. When the position touched with a finger F1 on the surface SB is moved, the mobile phone terminal 1 follows the movement to move the position of the pointer 30. In this manner, by displaying the pointer 30 indicating the third position P3 on the touch panel 2, the user can easily recognize which part of the back face of the mobile phone terminal 1 is touched with his/her finger.

The pointer 30 is a symbol and thus may have any shape and color, however, it is preferable that the symbol has such a size that the user easily recognizes. In addition, it is preferable that a large area of the symbol is made to be transparent so that it is not difficult for the user to recognize the icon 20 or the like displayed on the touch panel 2 and overlapping the pointer 30.

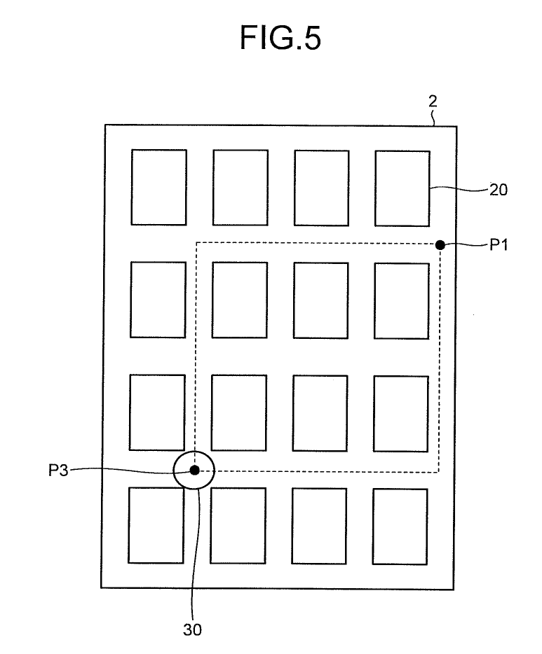

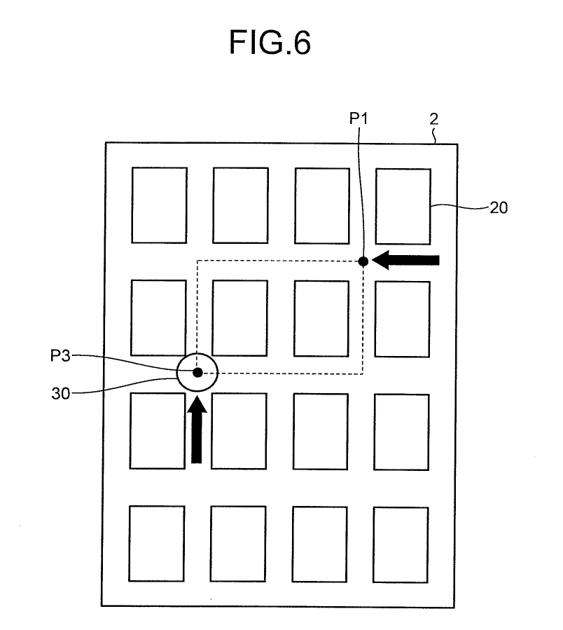

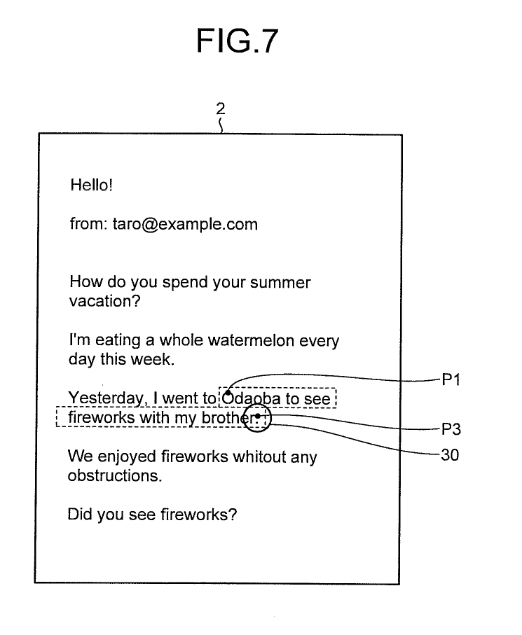

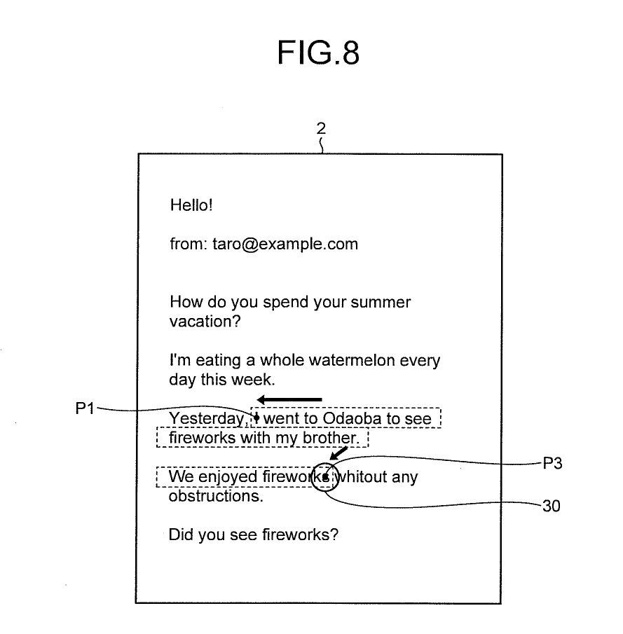

Next, the screen control executed by the mobile phone terminal 1 based on the operations detected by the touch panel 2 and the touch sensor 4 will be explained below with reference to FIG. 5 to FIG. 8. FIG. 5 is a diagram illustrating one example of the screen control for setting a selection range of icons. FIG. 6 is a diagram illustrating one example of the screen control for changing the selection range of the icons. FIG. 7 is a diagram illustrating one example of the screen control for setting a selection range of a text. FIG. 8 is a diagram illustrating one example of the screen control for changing the selection range of the text.

First, the screen control for setting and changing a selection range of icons will be explained below. FIG. 5 illustrates a case in which, in a state where a plurality of icons 20 are displayed (e.g., in an array) on the touch panel 2, a user' finger touches the surface SF of the mobile phone terminal 1 and the user's another finger touches the surface SB (i.e., the touch sensor 4) of the mobile phone terminal 1. Specific functions are allocated to the icons 20, respectively, displayed on the touch panel 2, and when one of the icons 20 is tapped, the mobile phone terminal 1 activates the function allocated to the tapped icon 20.

As used herein, a “tap” is an operation of briefly touching a touch panel or a touch sensor, e.g., with a finger, and releasing the finger therefrom.

As used herein, a “drag” or “dragging operation” is an operation of touching a touch panel or a touch sensor, e.g., with a finger, and moving the finger along the touch panel or the touch sensor while keeping the finger touched thereon.

As illustrated in FIG. 5, when touches with the fingers on the surface SF and the surface SB are detected in a state where the icons are displayed, the mobile phone terminal 1 sets a rectangular area, as a selection range, in which the first position P1 of a touch point on the surface SF and the third position P3 corresponding to a touch point on the surface SB are set as opposing corners. The mobile phone terminal 1 sets icons included in the selection range to be in a selected state. It should be noted that an icon partially included in the selection range may be or may not be set to be in a selected state.

For example, the mobile phone terminal 1 changes a display mode of the icons in the selected state, i.e., by changing a color of a background portion or by reducing brightness of the icons, to let the user know that these icons are in the selected state. The icons in the selected state are targets on which processes such as movement, copy, deletion, and activation of a corresponding function are collectively performed according to a subsequent operation by the user.

For example, when the user performs the dragging operation while the icons are kept selected, the icons in the selected state are collectively moved. If the mobile phone terminal 1 supports multitask, when the user releases the finger, the functions corresponding to the icons in the selected state are thereby collectively activated.

Additionally or alternatively, a menu is displayed when the user releases the finger to enable the user to select which of the processes such as movement, copy, deletion, and activation of one or more of the corresponding functions is collectively performed on the icons in the selected state.

As illustrated in FIG. 6, when the user moves the fingers to move the first position P1 and/or the third position P3 while maintaining the touches after the selection range is set, the mobile phone terminal 1 changes the selection range according to the movements of the first position P1 and the third position P3. In the example of FIG. 6, because the first position P1 located at the upper right corner of the selection range moves leftward and the third position P3 located at the lower left corner of the selection range moves upward, the mobile phone terminal 1 reduces the selection range according to the movements of the first position P1 and the third position P3. Even if either one of the first position P1 and the third position P3 moves, the selection range is changed.

In this way, in the screen control method according to the first embodiment, a selection range of icons is set based on the position touched on the front face and the position touched on the back face. The operation of touching the positions, with the fingers, which are set as opposing corners of a selection range to be set is intuitive for the user, so that the user can easily execute the operation. In addition, by setting a selection range based on two-point touches on the front face and the back face, the selection range setting operation is easily discriminated from the operations based on one-point touches, such as the operation of tapping an icon in order to activate the corresponding function, and a malfunction at the time of setting the selection range is thereby difficult to occur.

In the screen control method according to the first embodiment, the user can continuously and quickly perform the operation of changing the selection range directly after setting the selection range. For example, in a method in which the user drags his/her finger along the touch panel to surround a range and sets the range as a selection range, the user has to release the finger from the touch panel when the selection range is to be changed, which results in interruption of the operation. Another method requires a multi-touch touch panel or touch sensor which is expensive.

In the screen control method according to the first embodiment, although the selection range is set and changed based on two-point touches, however, only an one-point touch is to be detected on each of the front face and the back face, respectively. Therefore, a single-touch touch panel or a touch sensor at a comparatively low cost is used to achieve an intuitive and user-friendly operation as explained above, without using an expensive multi-touch touch panel or touch sensor (which is capable of detecting touches at a plurality of positions).

Subsequently, screen control for setting and changing a selection range of a text will be explained below. FIG. 7 represents a case where, in a state in which a text is displayed on the touch panel 2, the user's finger touches the surface SF of the mobile phone terminal 1 and the user's another finger touches the surface SB of the mobile phone terminal 1.

As illustrated in FIG. 7, when the touches of the fingers on the surface SF and the surface SB are detected in a state where the text is displayed, the mobile phone terminal 1 sets a selection range so as to select a range in which either one of the first position P1 of the touch point on the surface SF and the third position P3 corresponding to the touch point on the surface SB is determined as a start point and the other one is determined as an end point.

The mobile phone terminal 1 changes a display mode of the text in a selected state by highlighting a selected portion of the text or surrounding it with a frame, to notify the user that the portion of the text is in the selected state. The text in the selected state becomes a target on which the processes such as movement, copy, deletion, and format change are collectively performed according to a subsequent operation by the user.

For example, when carrying out a dragging operation while the text is kept selected, the user collectively moves the text in the selected state to a different location. In addition, a menu is displayed when the user releases the finger, to be selected by the user as to which of the processes such as the movement, the copy, the deletion, and the format change is to be collectively performed on the text in the selected state.

As illustrated in FIG. 8, when the user moves the fingers while maintaining the touches after the selection range is set and the first position P1 and the third position P3 are thereby moved, the mobile phone terminal 1 changes the selection range according to the movements of the first position P1 and the third position P3. In the example illustrated in FIG. 8, the first position P1 located at the start point of the selection range moves forward, and the third position P3 located at the end point of the selection range moves backward. Therefore, the mobile phone terminal 1 enlarges the selection range according to the movements of the first position P1 and the third position P3. Even when either one of the first position P1 and the third position P3 moves, the selection range is changed.

In this manner, in the screen control method according to the first embodiment, a selection range of any displayed items, including but not limited to, icons, text, images etc. can be set based on a position touched with the finger on the front face and a position touched therewith on the back face.

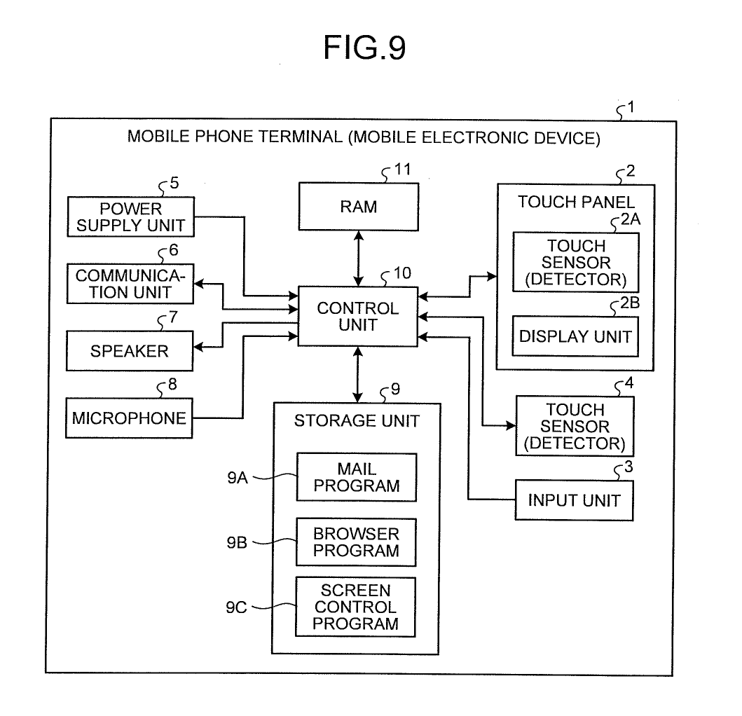

Next, a relationship between the functions and the control unit of the mobile phone terminal 1 will be explained below. FIG. 9 is a block diagram illustrating a schematic configuration of the functions of the mobile phone terminal 1 illustrated in FIG. 1. The mobile phone terminal 1 as illustrated in FIG. 9 includes the touch panel 2, the input unit 3, the touch sensor (detector) 4, a power supply unit 5, a communication unit 6, a speaker 7, a microphone 8, a storage unit 9, a control unit 10, and a random access memory (RAM) 11.

The touch panel 2 includes a display unit 2B and a touch sensor (detector) 2A overlapped on the display unit 2B. The touch sensor 2A is provided on the surface SF, and detects various operations (gestures) performed on the touch panel 2 as well as the position on the touch panel 2 where each of the operations is performed. The operations detected by the touch sensor 2A includes a tapping operation of briefly touching the finger on the surface of the touch panel 2), a dragging operation of moving the finger with the finger kept touched on the surface of the touch panel 2), and a pressing operation of pressing the finger against the surface of the touch panel 2. The display unit 2B is formed with, for example, a liquid crystal display (LCD) and an organic electro-luminescence (organic EL) panel, and displays characters, graphics, images, or the like.

The touch sensor 4 is provided on the top or inside of the surface SB, and detects various operations (gestures) performed on the surface SB as well as the position on the touch sensor 4 where each of the operations is performed. The operations detected by the touch sensor 4 include a tapping operation of briefly touching the finger on the surface SB), a dragging operation of moving the finger with the finger kept touched on the surface SB), and a pressing operation of pressing the finger against the surface SB. Any detection methods, including but not limited to, a pressure sensitive type detection method and a capacitive type detection method, may be adopted as the detection method of the touch sensor 2A and/or the touch sensor 4.

The input unit 3 receives a user operation through a physical button or so, and transmits a signal corresponding to the received operation to the control unit 10. The power supply unit 5 supplies electric power obtained from a battery or an external power supply to each of function units of the mobile phone terminal 1 including the control unit 10. The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The speaker 7 outputs speech of the other party on the telephone communication, a ring tone, or the like. The microphone 8 converts the speech of the user or other captured sounds to electrical signals.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores therein programs and data used for processes performed by the control unit 10. Specifically, the storage unit 9 stores therein a mail program 9A for transmitting/receiving or browsing mail, a browser program 9B for browsing Web pages, and a screen control program 9C for providing the screen control. The storage unit 9 also stores therein, in addition to the above ones, an operating system program for performing basic functions of the mobile phone terminal 1, and other programs and data such as address book data in which names, telephone numbers, mail addresses, and the like are registered.

The control unit 10 is, for example, a central processing unit (CPU), and integrally controls the operations of the mobile phone terminal 1. Specifically, the control unit 10 executes the program(s) stored in the storage unit 9 while referring to the data stored in the storage unit 9 as necessary, and executes the various processes by controlling the touch panel 2, the communication unit 6, and the like. The control unit 10 loads the program stored in the storage unit 9 or the data acquired/generated/processed through execution of the processes to the RAM 11 that provides a temporary storage area, as required. The program executed by the control unit 10 and the data to be referred to may be downloaded from a server over wireless communication by the communication unit 6.

For example, the control unit 10 executes the browser program 9B, to perform the function of displaying a Web page on the touch panel 2. The control unit 10 also executes the screen control program 9C, to provide various screen controls required for various programs to proceed with processes while interactively communicating with the user.

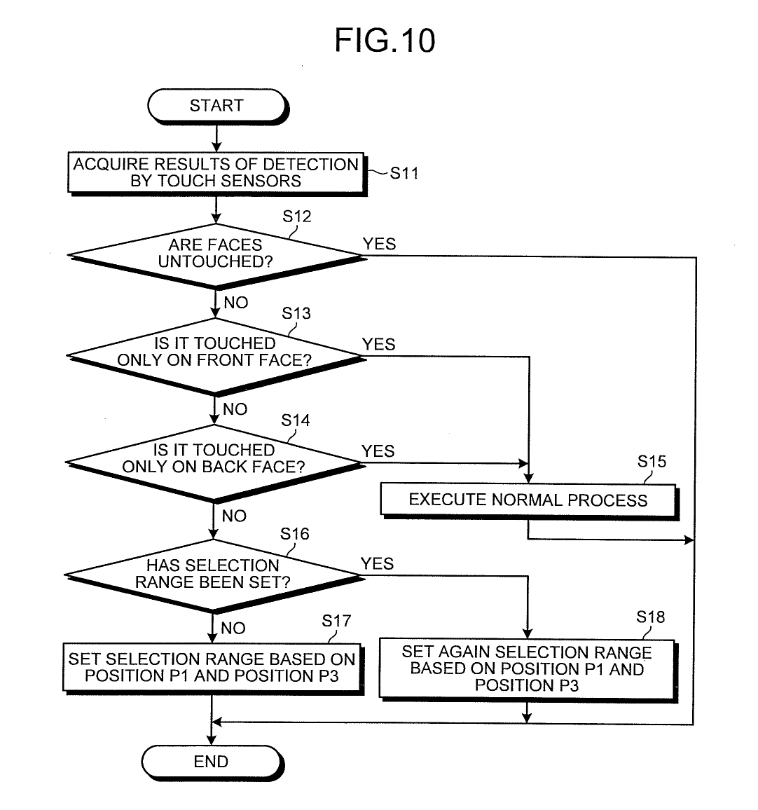

Next, operations performed when the mobile phone terminal 1 executes the screen control for operations of setting and changing a selection range will be explained below. FIG. 10 is a flowchart illustrating a processing procedure performed when the mobile phone terminal 1 executes the screen control for the operations of setting and changing a selection range. The processing procedure illustrated in FIG. 10 is repeatedly executed while one or more selectable items, such as an icon, a text, or the like, is displayed on the touch panel 2.

First, at Step S11, the control unit 10 acquires results of detection by the touch sensor 2A and the touch sensor 4. When it is detected by both the touch sensor 2A and the touch sensor 4 that both faces thereof are untouched, respectively (Yes at Step S12), the control unit 10 does not perform any particular process. When it is detected that at least one of the touch panel 2 and the touch sensor 4 is touched (No at Step S12), the control unit 10 proceeds to step S13.

When a touch is detected by either one of the touch sensor 2A (front face) and the touch sensor 4 (back face) (Yes at Step S13 or Yes at Step S14), the control unit 10 executes a normal process, at Step S15, performed when the touch is detected by either one of the touch sensor 2A and the touch sensor 4. The normal process mentioned here represents, for example, a process of activating a function, when an icon is tapped, corresponding to the tapped icon.

When touches are detected by both the touch sensor 2A and the touch sensor 4, that is, when touches are detected on both the front face and the back face of the mobile phone terminal 1 (No at Step S13 and No at Step S14), the control unit 10 determines whether the selection range has been set, at Step S16. When the selection range is set in the icons or text, information for specifying the location of the selection range is stored in the RAM 11. The control unit 10 checks whether the information is stored in the RAM 11 by referring to the RAM 11, to determine whether the selection range has been set.

When the selection range has not been set (No at Step S16), the control unit 10 determines a selection range based on the first position P1 and the third position P3 (the second position P2) at Step S17. The information for specifying the determined selection range is stored in the RAM 11 for subsequent processes. Meanwhile, when the selection range has been set (Yes at Step S16), the control unit 10 changes the selection range based on a current first position P1 and a current third position P3 (the second position P2) at Step S18, and updates the information for specifying the selection range in the RAM 11. The information for specifying the selection range is deleted from the RAM 11 when a predetermined operation for releasing the selection range is detected or when a certain process is executed on or according to the icon or the like in the selection range.

As explained above, the first embodiment is configured to set the selection range based on the position touched on the front face of the mobile phone terminal 1 and the position touched on the back face thereof, so that the user can easily set the selection range and a malfunction is difficult to occur upon setting of the selection range.

In the first embodiment, when a selection range of a text is to be set, the selection range is set so as to select a range in which either one of the first position P1 and the third position P3 is set as a start point and the other one is set as an end point. However, a rectangular area in which the first position P1 and the third position P3 are set as opposing corners may also be set as a selection range. The way to set the selection range in the above manner is called rectangular selection, and is useful for selecting a specific column of the text shaped in, for example, a tab-delimited table format.

The first embodiment is configured to change the selection range when the first position P1 and/or the third position P3 move(s) after the selection range is set. In this case, however, a display magnification of the screen may be changed. Therefore, in a second embodiment, an example of changing the display magnification of a screen in association with movements of the first position P1 and the third position P3 after the selection range is set will be explained below. A mobile phone terminal according to the second embodiment has the same configuration as that of the mobile phone terminal according to the first embodiment except for the control of the screen control program 9C which is different from the first embodiment. Therefore, the second embodiment will be explained below based on the mobile phone terminal 1.

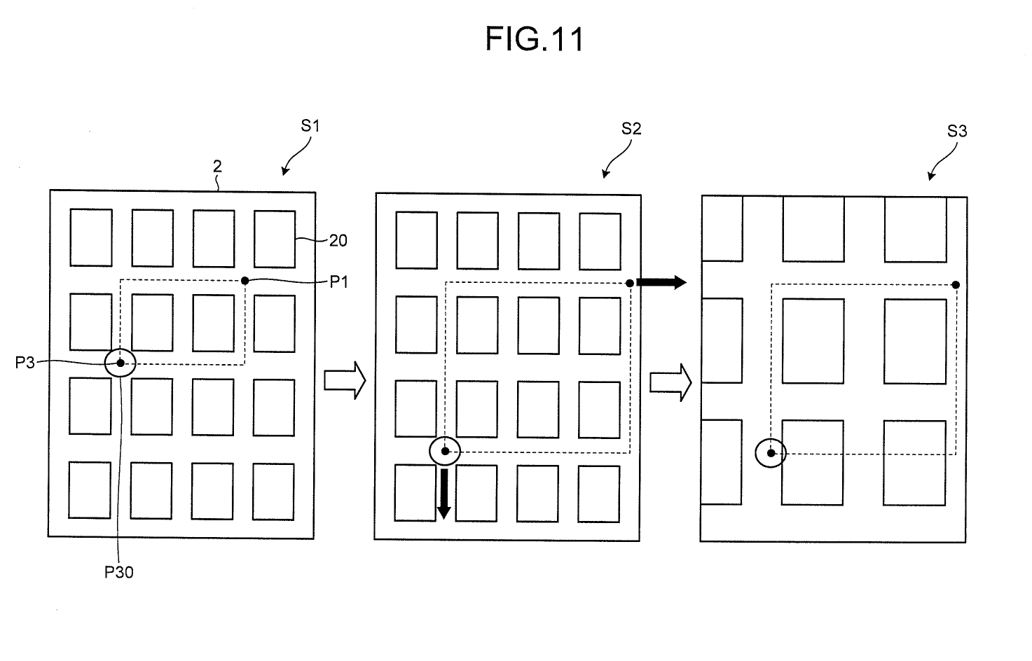

First, the screen control for an operation of changing a display magnification of a screen will be explained with reference to FIG. 11. FIG. 11 is a diagram illustrating one example of screen control for an operation of changing a display magnification of a screen.

At Step S1 in FIG. 11, in a state where a plurality of icons 20 are aligned to be displayed on the touch panel 2, a user's finger touches the surface SF of the mobile phone terminal 1 and the user's another finger touches the surface SB. In this manner, when the touches with the fingers on the surface SF and the surface SB are detected while the icons are displayed, the mobile phone terminal 1 sets a rectangular area, as a selection range, in which the first position P1 of a touch point on the surface SF and the third position P3 corresponding to a touch point on the surface SB are set as the opposing corners.

The mobile phone terminal 1 sets the icons included in the selection range to be in a selected state. The icons in the selected state are targets on which processes such as movement, copy, deletion, and activation of a corresponding function are collectively performed according to a subsequent operation by the user.

Subsequently, at Step S2, it is assumed that the user moves the fingers while keeping the touches and the first position P1 and the third position P3 thereby move. When the first position P1 and the third position P3 move while the selection range is set, the mobile phone terminal 1 changes, at Step S3, the display magnification of the screen according to a ratio between the size of the rectangular area in which the first position P1 and the third position P3 before the movements are set as the opposing corners and the size of the rectangular area in which the first position P1 and the third position P3 after the movements are set as the opposing corners. Even when either one of the first position P1 and the third position P3 moves, the display magnification is changed.

Here, the ratio to change the display magnification of the screen may be determined according to, for example, an area ratio between the rectangular areas before and after the movements, or may be determined according to a ratio between lengths of the long sides of the rectangular areas before and after the movements, or may be determined according to a ratio between lengths of the short sides of the rectangular areas before and after the movements. In addition, an aspect ratio may be changed in such a manner that a display magnification of the screen in a horizontal direction is determined according to a ratio of the lengths of the rectangular areas before and after the movements in the horizontal direction, and a display magnification of the screen in a vertical direction is determined according to a ratio of the lengths of the rectangular areas before and after the movements in the vertical direction.

In this way, in the screen control method according to the second embodiment, the display magnification of the screen is changed with the movements of the first position P1 and the third position P3 after the selection range is set. In this method, while the display magnification of the screen is changed based on two-point touches, only an one-point touch on each of the front face and the back face has to be detected. Therefore, a single-touch touch panel or a touch sensor at a comparatively low cost is used to achieve the intuitive and user-friendly operation as explained above, without using expensive multi-touch-touch sensors (which are capable of detecting touches at a plurality of positions).

FIG. 11 represents an example of changing the display magnification of the screen in the case where the icons are displayed. However, even in the case where other information such as a text and an image is displayed on the touch panel 2, the display magnification of the screen is changed by the same operation. Although FIG. 11 represents an example of increasing the display magnification of the screen, the display magnification of the screen can be reduced in a similar manner.

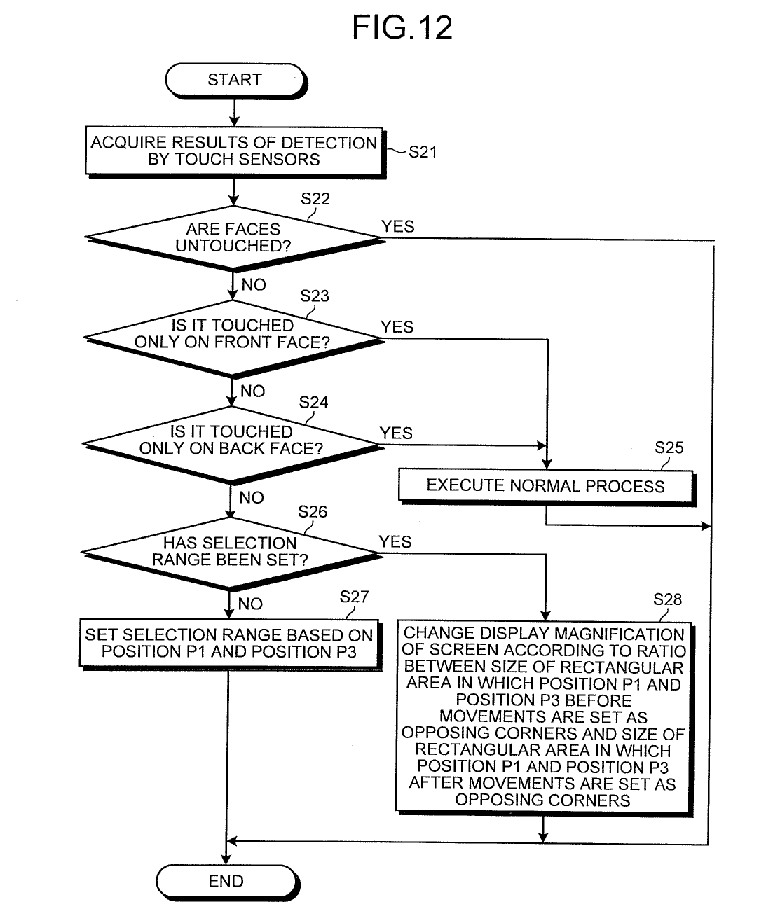

Next, an operation performed when the mobile phone terminal 1 executes the screen control for an operation of changing the display magnification of the screen will be explained below. FIG. 12 is a flowchart illustrating a processing procedure when the mobile phone terminal 1 executes the screen control for the operation of changing the display magnification of the screen. The processing procedure illustrated in FIG. 12 is repeatedly executed while the screen displayed on the touch panel 2 is in a display-magnification changeable state.

First, at Step S21, the control unit 10 acquires results of detection by the touch sensor 2A and the touch sensor 4. When it is detected by both the touch sensor 2A and the touch sensor 4 that both faces thereof are untouched, respectively (Yes at Step S22), the control unit 10 does not perform any particular process. When it is detected that at least one of the touch panel 2 and the touch sensor 4 is touched (No at Step S22), the control unit 10 proceeds to step S23.

When a touch is detected by either one of the touch sensor 2A (front face) and the touch sensor 4 (back face) (Yes at Step S23 or Yes at Step S24), the control unit 10 executes a normal process, at Step S25, performed when the touch is detected by either one of the touch sensor 2A and the touch sensor 4. The normal process mentioned here represents, for example, a process of activating a function, when an icon is tapped, corresponding to the tapped icon.

When touches are detected by both the touch sensor 2A and the touch sensor 4, that is, when touches are detected on both the front face and the back face of the mobile phone terminal 1 (No at Step S23 and No at Step S24), the control unit 10 determines whether the selection range has been set, at Step S26.

When the selection range has not been set (No at Step S26), the control unit 10 determines a selection range based on the first position P1 and the third position P3 (the second position P2) at Step S27. The information for the determined selection range is stored in the RAM 11 for subsequent processes. Meanwhile, when the selection range has been set (Yes at Step S26), the control unit 10 changes the display magnification of the screen according to a ratio between the size of the rectangular area in which the first position P1 and the third position P3 (the second position P2) before the movements are set as the opposing corners and the size of the rectangular area in which the first position P1 and the third position P3 after the movements are set as the opposing corners.

As explained above, the second embodiment is configured to change the display magnification of the screen based on the movement(s) of the fingers on the front face and/or the back face of the mobile phone terminal 1 after the selection range is set. Therefore, the user can easily change the display magnification of the screen and a malfunction is difficult to occur upon the operation for changing the display magnification.

The embodiments have explained the example of enabling the operation of setting a selection range using the touch panel on the front face and the touch sensor on the back face, however, any other operation can be performed by using these detectors. Therefore, in a third embodiment, an example of enabling other operations, other than selection range setting, using the touch panel on the front face and the touch sensor on the back face will be explained below. In the following explanation, the same reference numerals denote the same or similar components that have been already explained. In addition, repetitive explanations may be omitted.

A mobile phone terminal (mobile electronic device) 31 according to the third embodiment will be explained below with reference to the drawings. The mobile phone terminal 31 has the same overall configuration as that of the mobile phone terminal 1 as illustrated in FIG. 1, FIG. 2, etc. In other words, the mobile phone terminal 31 is provided with the touch panel 2 on the surface SF of the front face and with the touch sensor 4 on the surface SB of the back face.

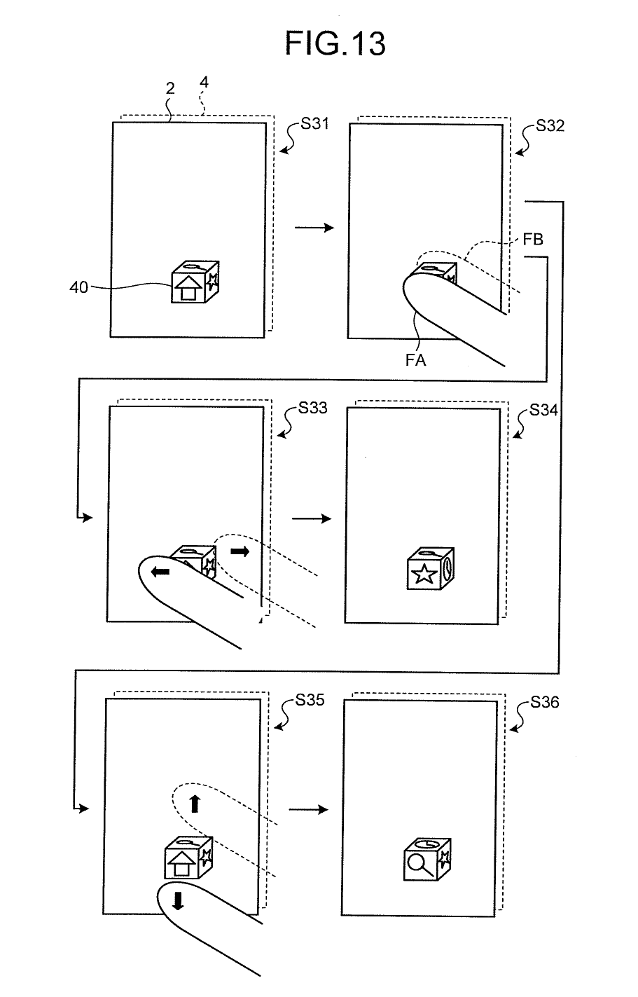

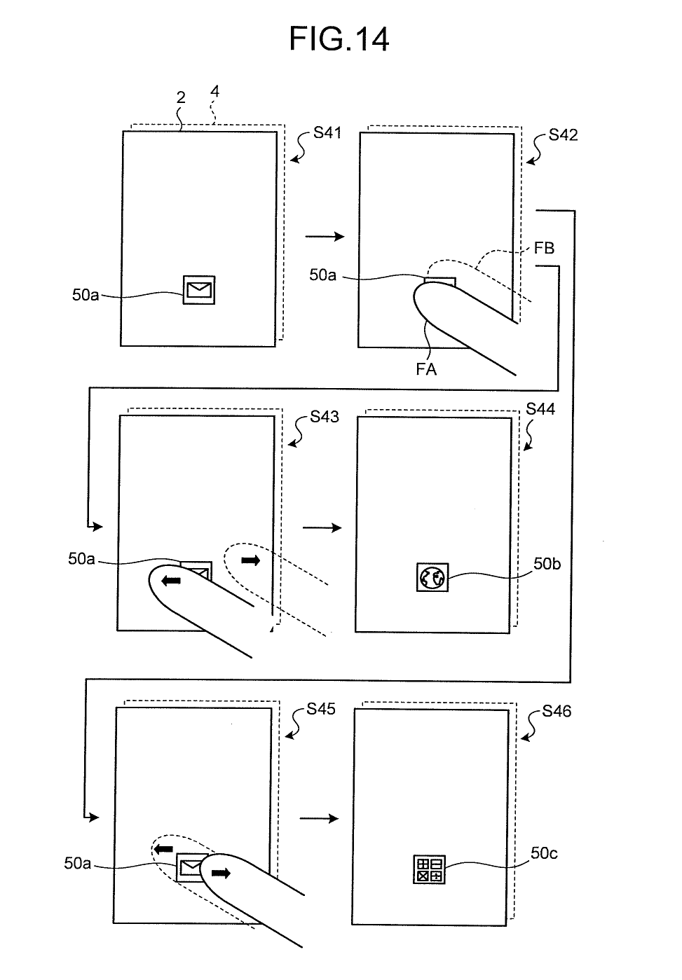

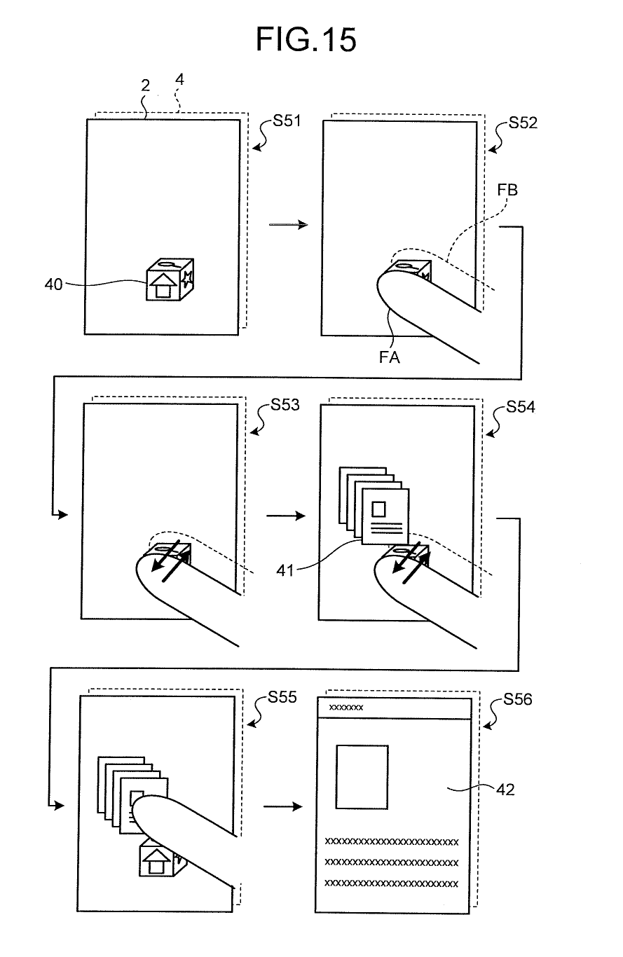

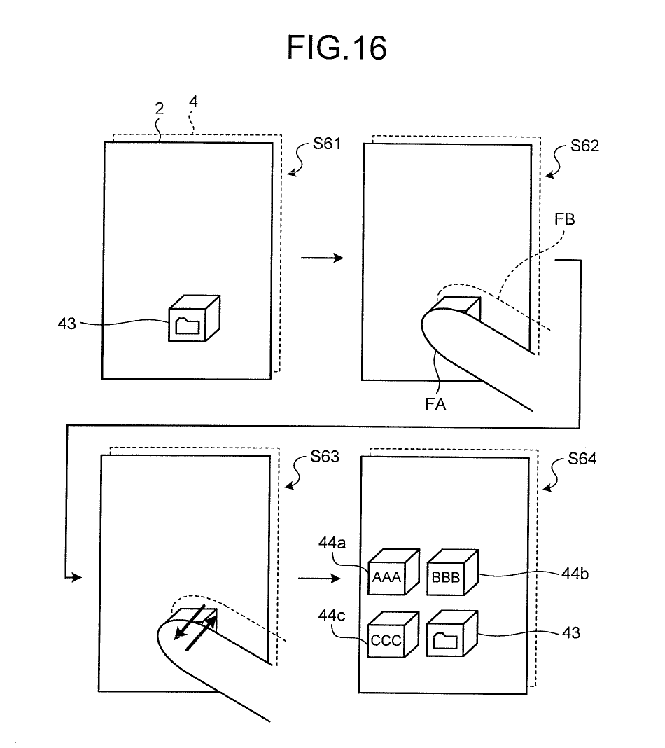

First, the screen control executed by the mobile phone terminal 31 according to the third embodiment based on the operations detected by the touch panel 2 and the touch sensor 4 will be explained below with reference to FIG. 13 to FIG. 16. FIG. 13 is a diagram illustrating one example of screen control for an operation of rotating a three-dimensionally shaped icon. FIG. 14 is a diagram illustrating one example of screen control for an operation of transforming a two-dimensionally shaped icon. FIG. 15 is a diagram illustrating one example of screen control for an operation of pressing the three-dimensionally shaped icon. FIG. 16 is a diagram illustrating one example of another screen control for the operation of pressing a three-dimensionally shaped icon. To simplify the illustrations, FIG. 13 to FIG. 16 illustrate only the touch panel 2 and the touch sensor 4, while omitting other components of the mobile phone terminal 31.

The screen control for the operation of manipulating, e.g., rotating, a three-dimensionally shaped icon will be explained below. At Step S31 in FIG. 13, the mobile phone terminal 31 displays an icon 40 on the touch panel 2. The icon 40 has a cubic shape and is stereoscopically displayed using oblique projection or the like. Specific functions are allocated to faces of the icon 40, and when the icon 40 is tapped, the mobile phone terminal 31 activates a function corresponding to the face displayed as the front (dominant) face, among the functions allocated to the faces of the icon 40 respectively.

When the finger is put on the icon 40 and then a dragging operation is carried out, the mobile phone terminal 31 moves the icon 40 along with the finger during the dragging operation, e.g., to a location where no other icons are displayed.

Allocated to the faces of the icon 40 illustrated in FIG. 13 are functions related to a Web browser, and at Step S31, a face with a house pictogram is displayed as the front face, a face with a magnifying glass pictogram is displayed as a top face, and a face with a star pictogram is displayed as a right side face.

The house pictogram indicates that a function of displaying a Web page registered as a home page is allocated to the face with this pictogram. The magnifying glass pictogram indicates that a function of displaying a Web page for a search site is allocated to the face with this pictogram. The star pictogram indicates that a function of displaying a list of bookmarks is allocated to the face with this pictogram. When the icon 40 is tapped at Step S31, the mobile phone terminal 31 displays the Web page registered as the home page on the touch panel 2.

As illustrated at Step S32, it is assumed that a finger FA of the user touches a position on the touch panel 2 where the icon 40 is displayed, and a finger FB of the user touches the touch sensor 4 at, or in a vicinity of, a position on the back side corresponding to the touched position on the touch panel 2. Therefore, in the case of Step S32, the icon 40 is displayed between the position where the touch panel 2 detects the touch with the finger FA and the position where the touch sensor 4 detects the touch with the finger FB.

In this manner, when the icon 40 is displayed between the position where the touch panel 2 detects the touch and the position where the touch sensor 4 detects the touch, the mobile phone terminal 31 determines that the icon 40 is pinched by the user's fingers. When it is determined that the icon 40 is pinched by the user's fingers, the mobile phone terminal 31 vibrates at least one of the touch panel 2 and the touch sensor 4 in order to inform the user accordingly.

In this way, the vibration of the touch panel 2 or the like confirms to the user that the pinching operation of the icon 40 is recognized by the mobile phone terminal 31. To vibrate the touch panel 2 or the like, any known system, such as a system of using, for example, a piezoelectric element can be used. In addition, not only the touch panel 2 and/or the touch sensor 4, but the whole mobile phone terminal 31 may be vibrated. Moreover, by using any means other than vibrations, such as blinking of the touch panel 2 and/or audible signals, the user may be informed of the recognition.

Subsequently, as illustrated at Step S33, if it is detected that the user moves the finger FA leftward in FIG. 13 with the finger FA kept touched on the touch panel 2, and/or that the user moves the finger FB rightward in FIG. 13 with the finger FB kept touched on the touch sensor 4, the mobile phone terminal 31 changes the direction of the icon 40 according to the detected movement direction and/or movement distance of the finger(s).

Specifically, the mobile phone terminal 31 rotates, e.g., around the center of the icon 40 as a center of rotation, the front face of the icon 40 by a rotation amount according to the movement distance in the movement direction in which the finger FA moves while being kept touched on the touch panel 2, and rotates the back face of the icon 40 by a rotation amount according to the movement distance in the direction in which the finger FB moves while being kept touched on the touch sensor 4. It is preferable that the sensitivity of rotation or the magnitude of the rotation amount of the icon with respect to the movement distance of the finger(s) can be set by the user according to user's preference.

When it is detected that the touch with at least one of the finger FA and the finger FB is ended, as illustrated at Step S34, the mobile phone terminal 31 corrects the direction of the icon 40 so that a face closest to the front face at that time turns to the front face. Because the icon 40 is rotated leftward according to the movements of the finger FA and the finger FB at Step S33, the face with the star pictogram moves from the right side face to the front face at Step S34. When the icon 40 is tapped at Step S34, the mobile phone terminal 31 displays a list of bookmarks on the touch panel 2.

The mobile phone terminal 31 may not need to correct the direction of the icon 40 so that the face closest to the front face at that time turns to the front face as illustrated at Step S34. When it is detected that the touch with at least one of the finger FA and the finger FB is ended, the mobile phone terminal 31 may activate a function allocated to a face closest to the front face.

As illustrated at Step S35, if it is detected that the user moves the finger FA from the state at Step S32 downward in FIG. 13 with the finger FA kept touched on the touch panel 2, and/or that the user moves the finger FB upward in FIG. 13 with the finger FB kept touched on the touch sensor 4, the mobile phone terminal 31 rotates, around the center of the icon 40 as a center of rotation, the front of the icon 40 by a rotation amount according to the movement distance in the movement direction in which the finger FA moves while being kept touched on the touch panel 2, and rotates the back face of the icon 40 by a rotation amount according to the movement distance in the movement direction in which the finger FB moves while being kept touched on the touch sensor 4.

When it is detected that the touch with at least one of the finger FA and the finger FB is ended, as illustrated at Step S36, the mobile phone terminal 31 corrects the direction of the icon 40 so that a face closest to the front face at that time turns to the front face. Because the icon 40 is rotated downward according to the movements of the finger FA and the finger FB at Step S35, the face with the magnifying glass pictogram moves from the top face to the front face at Step S36. When the icon 40 is tapped at Step S36, the mobile phone terminal 31 displays a Web page for the search site on the touch panel 2.

In this manner, the mobile phone terminal 31 displays a stereoscopic icon whose faces are allocated with specific functions respectively, and switches the function to be activated according to an intuitive and user-friendly operation such as pinching and rotating the icon with the fingers. Therefore, the mobile phone terminal 31 can provide satisfactory operability to the user while making many functions available through the operation of the icon.

FIG. 13 represents the example in which related functions, such as the functions related to a Web browser, are associated with the faces of the icon respectively, however, unrelated functions can be associated with the faces of the icon.

FIG. 13 represents the example in which, when an icon is displayed between the first position P1 and the second position P2, the mobile phone terminal 31 determines that the icon is selected by the user. Similarly, the mobile phone terminal 31 can determine that the icon is selected by the user when it is detected that both the first position P1 and the third position P3 is on the same icon.

FIG. 13 represents the example in which a three-dimensionally shaped object is stereoscopically displayed, however, only the front face of the three-dimensionally shaped object may be two-dimensionally displayed. In addition, the object displayed on the touch panel 2 to be operated is not necessarily a three-dimensionally shaped object, but may be a two-dimensionally shaped object.

An example of displaying a two-dimensionally shaped object will be explained below with reference to FIG. 14. At Step S41 in FIG. 14, the mobile phone terminal 31 displays an icon 50a on the touch panel 2. The icon 50a has a two-dimensional shape. A plurality of icons, including icon 50a, are arranged in a hierarchical order (hierarchy) at a position where the icon 50a is displayed on the touch panel 2. Specific functions are allocated to the hierarchically arranged icons, respectively.

The mobile phone terminal 31 displays an icon, among the hierarchically arranged icons, at the top of the hierarchy on the touch panel 2, and when the icon at the top of the hierarchy (that is the icon displayed on the touch panel 2) is tapped, the mobile phone terminal 31 activates a function corresponding to the icon at the top of the hierarchy. At step S41, the icon 50a is at the top of the hierarchy. When the icon 50a is tapped, the mobile phone terminal 31 activates a function corresponding to the icon 50a.

As illustrated at Step S42, it is assumed that a finger FA of the user touches a position on the touch panel 2 where the icon 50a is displayed, and a finger FB of the user touches the touch sensor 4 at, or in a vicinity of, a position on the back side corresponding to the touched position on the touch panel 2. Therefore, in the case of Step S42, the icon 50a is displayed between the position where the touch panel 2 detects the touch with the finger FA and the position where the touch sensor 4 detects the touch with the finger FB.

In this manner, when the icon 50a is displayed between the position where the touch panel 2 detects the touch and the position where the touch sensor 4 detects the touch, the mobile phone terminal 31 determines that the icon 50a is selected by the user. When it is determined that the icon 50a is selected by the user, the mobile phone terminal 31 informs the user accordingly using vibrations or the like.

Subsequently, as illustrated at Step S43, if it is detected that the user moves the finger FA leftward in FIG. 13 with the finger FA kept touched on the touch panel 2, and/or that the user moves the finger FB rightward in FIG. 13 with the finger FB kept touched on the touch sensor 4, the mobile phone terminal 31 changes the hierarchy including icon 50a according to the detected movement direction and/or the detected movement distance of the finger(s).

At Step S44, icon 50b is displayed on the touch panel 2. The icon 50b was at the second level of the hierarchy at step S41. The mobile phone terminal 31 shifts the icon 50b to the top of the hierarchy in response to the movement detected at step S43 and displays the icon 50b, rather than the icon 50a, on the touch panel 2.

The mode for changing of the hierarchy is not limited to the above example. The mobile phone terminal 31 may change the mode for changing of the hierarchy according to the detected movement direction and/or the detected movement distance. For example, as illustrated at Step S45, when it is detected that the fingers move in a direction opposite to the case at step S43, the mobile phone terminal 31 may shift an icon at the bottom of the hierarchy to the top. Accordingly, instead of the icon 50a, an icon 50c which was at the bottom of the hierarchy at step S41, is displayed on the touch panel 2 at step S46.

Another mode for changing the hierarchy is based on the strength and/or the duration of the detected pressure(s) of at least one of the touches.

For example, after the mobile phone terminal 31 has recognized that the icon 50a is selected by the user, if a pressure having a strength at or beyond a predetermined level is detected by the touch panel 2 and/or the touch sensor 4 (which indicates that the user further strongly presses the finger FA against the touch panel 2 and/or that the user further strongly presses the finger FB against the touch sensor 4), the mobile phone terminal 31 displays, instead of the current icon (e.g., icon 50a), an icon at a different level in the hierarchy (e.g., icon 50b or 50c). If the user continues to press strongly the finger FA against the touch panel 2 and/or the finger FB against the touch sensor 4, the mobile phone terminal 31 continuously displays one icon after another until the pressing is stopped, e.g., until the strength of the detected pressure falls below the predetermined level. In this manner, the user can cycle through the icons in the hierarchy simply by increasing the pressure at least one of the touches after selecting the top (current) icon of the hierarchy.

Alternatively or additionally, after the mobile phone terminal 31 has recognized that the icon 50a is selected by the user, if the touch with the finger FA on the touch panel 2 and/or the touch with the finger FB on the touch sensor 4 is/are continuously detected over a predetermined period without movements in the positions of touch points, the mobile phone terminal 31 displays, instead of the current icon (e.g., icon 50a), an icon at a different level in the hierarchy (e.g., icon 50b or 50c). As explained herein, one way to recognize the length of time (duration) of the touch is to use a sensor, such as a capacitive type sensor, which is not sensitive to pressure.

In this manner, even if the object displayed on the touch panel 2 to be operated is a two-dimensionally shaped object, the mobile phone terminal 31 can provide satisfactory operability to the user while making many functions available through the operation of the icon.

Subsequently, the screen control for the operation of pressing the three-dimensionally shaped icon will be explained below. At Step S51 of FIG. 15, similarly to Step S31 of FIG. 13, the mobile phone terminal 31 displays the icon 40 on the touch panel 2.

As illustrated at Step S52, it is assumed that the finger FA of the user touches a position on the touch panel 2 where the icon 40 is displayed, and the finger FB of the user touches the touch sensor 4 at, or in a vicinity of, a position on the back side corresponding to the touched position on the touch panel 2. In this case, similarly to Step S32 of FIG. 13, the mobile phone terminal 31 determines that the icon 40 is pinched by the user's fingers, and informs the user accordingly using, for example, vibrations.

As illustrated at Step S53, if it is detected that the user further strongly presses the finger FA against the touch panel 2 and/or that the user further strongly presses the finger FB against the touch sensor 4, the mobile phone terminal 31 displays other objects related to the icon 40.

For example, as illustrated at Step S54, the mobile phone terminal 31 displays thumbnail images 41 of Web pages previously displayed by the Web browser on the touch panel 2, as the objects related to the icon 40 to which the functions for the Web browser are allocated. The mobile phone terminal 31 displays the thumbnail images 41 of the Web pages in order of the latest Web page displayed by the Web browser according to the strength of pressure detected by the touch panel 2 and/or the touch sensor 4.

That is, when a pressure having a strength at a first level is detected by the touch panel 2 and/or the touch sensor 4, the mobile phone terminal 31 displays a thumbnail image 41 of a Web page which is displayed by the Web browser at a time closest to the time of the detection of such pressure. When a pressure having a strength at a second level higher than the first level is detected by the touch panel 2 and/or the touch sensor 4, the mobile phone terminal 31 displays a thumbnail image 41 of a Web page which is displayed by the Web browser at a time second closest to the time of the detection. Similarly, the mobile phone terminal 31 displays the thumbnail images 41 of the Web page in chronological order according to the detected strength of pressure.

The thumbnail images 41 displayed at Step S54 are created each time a Web page is displayed by the Web browser, and a predetermined number of thumbnail images are stored in the mobile phone terminal 31 (e.g., in a RAM or storage device similar to those described with respect to the mobile phone terminal 1) in order from the latest one, in association with a uniform resource locator (URL) of the Web page.

As illustrated at Step S55, if it is detected that the user stops the operation of pressing the finger and taps a thumbnail image 41 with his/her finger, the mobile phone terminal 31 displays a Web page 42 corresponding to the tapped thumbnail image 41 on the touch panel 2, as illustrated at Step S56.

In this manner, the mobile phone terminal 31 displays other objects related to an icon according to an intuitive and user-friendly operation, such as pinching and pressing an icon, e.g., a stereoscopic icon. It should be noted that the other objects displayed when the operation of pressing the icon is recognized may be a single object or multiple objects. In addition, which of the objects is displayed when the operation of pressing the icon is recognized may be determined according to a function corresponding to a face of the icon displayed as the front face. The strength of the pressure at which the user presses the finger may be determined based on either one of the strength of the pressure detected by the touch panel 2 and the strength of the pressure detected by the touch sensor 4.

In the example illustrated in FIG. 15, as an object related to the icon, the data processed by one of the functions corresponding to the icon is displayed, however, the object related to the icon is not limited thereto. For example, as illustrated in FIG. 16, when the pinched icon is a container object having a function as a container (also called “folder”) and when the operation of pressing the icon is recognized, the other icons stored in the container icon may be displayed.

Here, it is assumed that icons are hierarchically managed. For example, an expression “icon A stores therein icon B” means that the icon A includes the icon B as an element lower in the hierarchy.

At Step S61 of FIG. 16, the mobile phone terminal 31 displays an icon 43 on the touch panel 2. The icon 43 has a cubic shape and is stereoscopically displayed using oblique projection or the like. The icon 43 includes a function as a container for storing therein other icons.

As illustrated at Step S62, it is assumed that the finger FA of the user touches a position on the touch panel 2 where the icon 43 is displayed, and the finger FB of the user touches the touch sensor 4 at, or in a vicinity of, a position on the back side corresponding to the position on the touch panel 2. In this case, the mobile phone terminal 31 determines that the icon 43 is pinched by the user's fingers, and informs the user accordingly using, for example, vibrations.

As illustrated at Step S63, if it is detected that the user further strongly presses the finger FA against the touch panel 2, and/or that the user further strongly presses the finger FB against the touch sensor 4, the mobile phone terminal 31 displays icons 44a to 44c stored in the icon 43 on the touch panel 2, as illustrated at Step S64.

In this way, the mobile phone terminal 31 provides intuitive and user-friendly operability to the user in such a manner that an icon having the function as a container is pressed to display the other icons stored in the container icon.

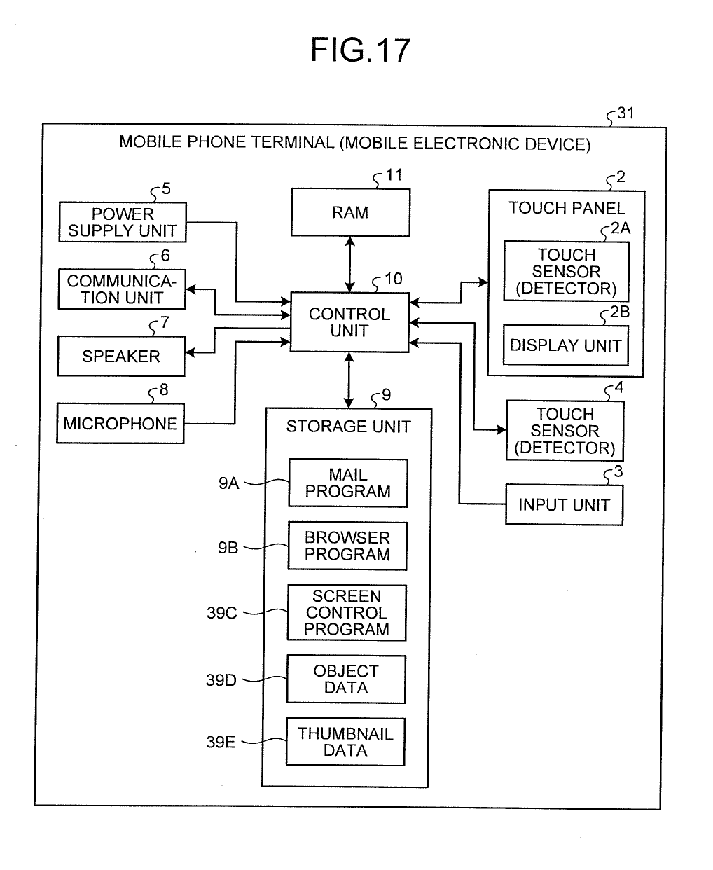

Next, the relationship between the functions and the control unit in the mobile phone terminal 31 will be explained below. FIG. 17 is a block diagram illustrating a schematic configuration of the mobile phone terminal 31. The mobile phone terminal 31 as illustrate in FIG. 17 includes the touch panel 2, the input unit 3, the touch sensor 4, the power supply unit 5, the communication unit 6, the speaker 7, the microphone 8, the storage unit 9, the control unit 10, and the RAM 11.

The storage unit 9 stores therein a mail program 9A for transmitting/receiving and browsing mail, a browser program 9B for browsing a Web page, a screen control program 39C for providing the screen control having been explained with reference to FIG. 13 to FIG. 16, object data 39D storing therein information for various icons to be displayed on the touch panel 2, and thumbnail data 39E storing therein thumbnail images 41 and URLs in association with each other, respectively. The storage unit 9 also stores therein an operating system program for performing a basic function of the mobile phone terminal 31, and other programs and data such as address book data in which names, telephone numbers, mail addresses, and the like are registered.

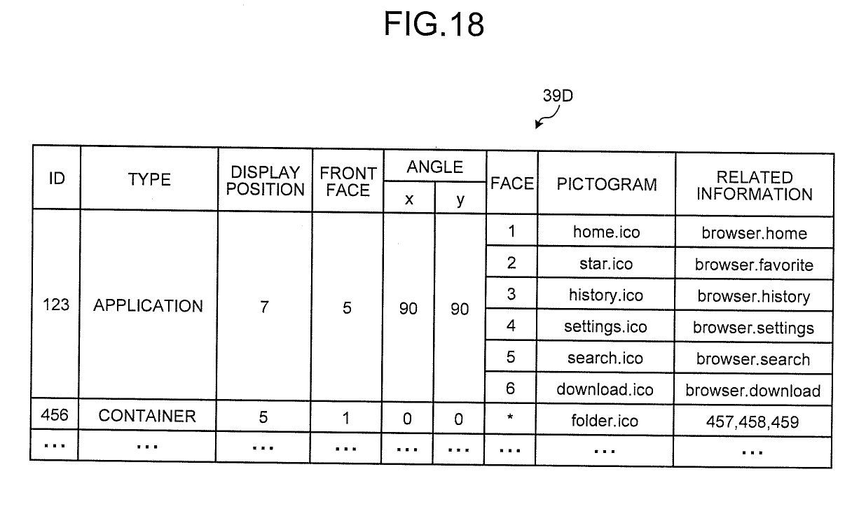

One example of the object data 39D is illustrated in FIG. 18. The object data 39D includes items, such as ID, Type, Display Position, Front Face, Angle, Face, Pictogram, Related Information, and stores therein the information for each icon. Stored under the item ID is an identifier for identifying the icon.

Stored under the item Type is a value that indicates a type of the icon. For example, when a value that indicates “Application” is stored under the item Type, this indicates that the icon corresponds to a function provided by an application program, such as the browser program 9B. When a value that indicates “Container” is stored under the item Type, this indicates that the icon has a function as a container.

Stored under the item Display Position is a value that indicates a position where the icon is displayed on the touch panel 2. For example, regions displaying various icons are previously set in a matrix of cells in the touch panel 2, and a value that indicates one of the regions is stored under the item Display Position. A number indicating a face to be displayed as the front face of the icon is stored under the item Front Face.

Set under the item Angle are values that indicate how to rotate the icon from its initial state in an x-axis direction and in a y-axis direction, respectively. For example, when the icon is first displayed, 0 is set as x and 0 is set as y under the item Angle. When the icon is rotated 90 degrees leftward from the initial state and 90 degrees downward according to the user operation, 90 is set as x and 90 is set as y under the item Angle.

Stored under the items Face, Pictogram, and Related Information is information for each face of the icon in association with the face. Set under the item Face is a value for identifying the face of the icon. When a value that indicates “*” is set under the item Face, this indicates that all the faces are set in a similar manner. Stored under the item Pictogram is an image data name of a pictogram or the like as information for specifying a pictogram displayed on the face of the icon.

Stored under the item Related Information is information related to the icon according to the type of the icon. For example, when the value that indicates “Application” is set under the item Type, information for specifying a function to be activated when the icon is tapped is stored under the item Related Information. When the value that indicates “Container” is set under the item Type, a list of identifiers (IDs) of the icons stored in the container icon is stored under the items Related Information of the container icon.

The control unit 10 illustrated in FIG. 17 executes the program(s) stored in the storage unit 9 while referring to the data stored in the storage unit 9 as required, and controls the touch panel 2, the communication unit 6, or the like, to execute various processes. For example, by executing the browser program 9B, the control unit 10 performs functions of displaying a Web page, storing one or more thumbnail and URL of the displayed Web page in the thumbnail data 39E, and displaying a list of bookmarks. By executing the screen control program 39C, the control unit 10 provides the screen control for the operation of rotating the icon and the operation of pressing the icon while updating the object data 39D.

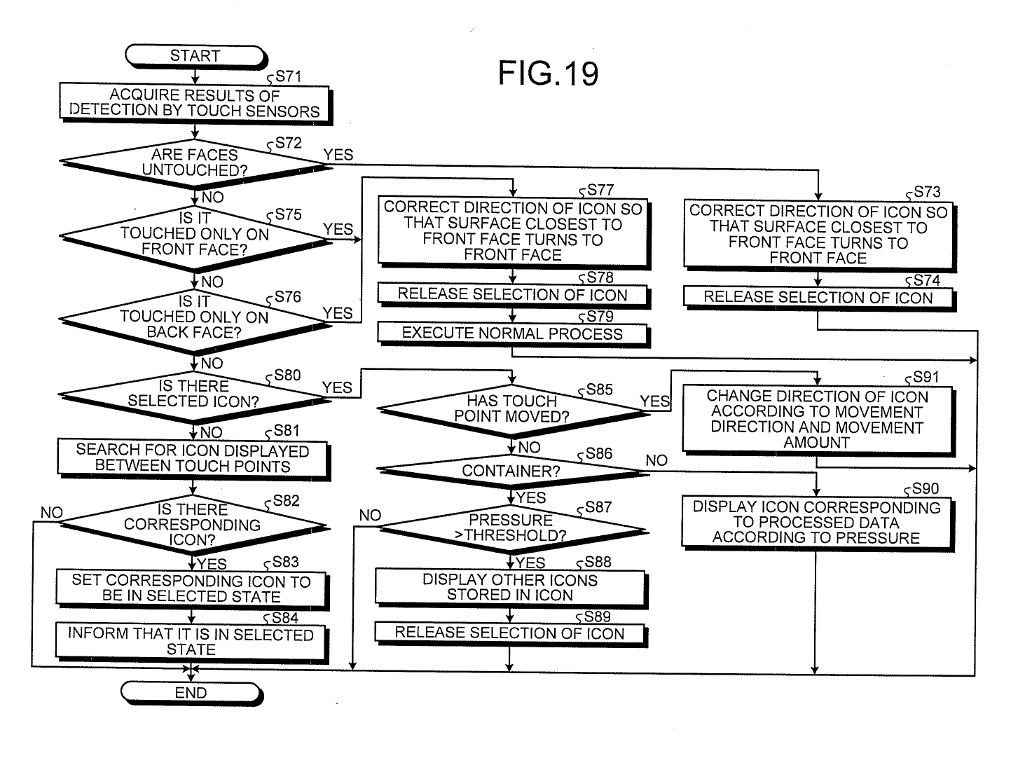

Next, operations when the mobile phone terminal 31 executes the screen control for the operation of rotating the icon and the operation of pressing the icon will be explained below. FIG. 19 is a flowchart illustrating a processing procedure when the mobile phone terminal 31 executes the screen control for the operation of rotating a three-dimensionally shaped icon and the operation of pressing the icon. The processing procedure illustrated in FIG. 19 is repeatedly executed while the three-dimensionally shaped icon is displayed on the touch panel 2. Various icons registered in the object data 39D are displayed on the touch panel 2.

First, at Step S71, the control unit 10 acquires results of detection by the touch sensor 2A and the touch sensor 4. When it is detected by both the touch sensor 2A and the touch sensor 4 that both faces thereof are untouched, respectively (Yes at Step S72), if there is any icon in a selected state, the control unit 10 corrects the direction of the icon so that a face closest to the front face turns to the front face at Step S73. The control unit 10 then releases the selection of the icon at Step S74. The icon in the selected state is an icon as a target for a pinching operation and as a target for a current operation.

When a touch is detected only by the touch sensor 2A, that is, when a touch is detected only on the front of the mobile phone terminal 31 (No at Step S72 and Yes at Step S75), or, when a touch is detected only by the touch sensor 4, that is, when a touch is detected only on the back face of the mobile phone terminal 31 (No at Step S75 and Yes at Step S76), if there is any icon in the selected state, the control unit 10 corrects the direction of the icon so that a face closest to the front face turns to the front face at Step S77. The control unit 10 then releases the selection of the icon at Step S78.

The control unit 10 executes a normal process, at Step S79, performed when the touch is detected by either one of the touch sensor 2A and the touch sensor 4 (i.e., the icon is tapped). The normal process mentioned here represents, for example, a process of activating a function corresponding to the front face of the tapped icon.

When touches are detected by both the touch sensor 2A and the touch sensor 4, that is, when touches are detected on both the front and the back face of the mobile phone terminal 31 (No at Step S76), the control unit 10 determines whether there is any icon in the selected state, at Step S80. When there is no icon in the selected state (No at Step S80), at Step S81, the control unit 10 searches for an icon displayed between the touch point on the touch sensor 2A and the touch point on the touch sensor 4 from the icons whose information is stored in the object data 39D.

When there is no corresponding icon (No at Step S82), the control unit 10 does not perform any particular process. When there is a corresponding icon (Yes at Step S82), the control unit 10 sets the icon to be in the selected state at Step S83, and, at Step S84, informs the user that the operation of pinching the icon is recognized, using vibrations or the like.

At Step S80, when there is an icon already in the selected state (Yes at Step S80), the control unit 10 determines whether at least one of the touch points moves, at Step S85. When the touch point(s) does not move (No at Step S85), the control unit 10 determines whether the icon in the selected state functions as the container, at Step S86.

When the icon in the selected state functions as the container (Yes at Step S86), the control unit 10 determines whether the pressure detected by the touch sensor 2A and/or the touch sensor 4 is greater than a threshold, at Step S87. When the detected pressure is greater than the threshold (Yes at Step S87), the control unit 10 displays other icons stored in the container icon at Step S88, and releases the selection of the container icon in the selected state, at Step S89. When the detected pressure is smaller than the threshold (No at Step S87), the control unit 10 does not perform any particular process.

Meanwhile, when the icon in the selected state does not function as a container (No at Step S86), the control unit 10 displays objects such as thumbnails corresponding to the data processed by the function corresponding to the icon in the selected state, at Step S90. At this time, the control unit 10 preferably displays objects, in the order of the most recently processed object being displayed first, according to the strength of the pressure detected by the touch sensor 2A and/or the touch sensor 4.

At Step S85, when at least one of the touch points has moved (Yes at Step S85), at Step S91, the control unit 10 updates the values of the item Angle in the row of the object data 39D corresponding to the icon in the selected state, according to the movement direction and the amount of the movement of the touch point(s), and changes the direction of the icon on the touch panel 2 based on the updated angle values.

As explained above, the third embodiment is configured to display the stereoscopic icon and execute the processes according to the operations of pinching and rotating the icon or the operations of pinching and pressing the icon. Therefore, the mobile phone terminal 31 can provide satisfactory operability to the user while making many functions available through the operation of the icon.

The embodiment represents the example of displaying the icon having a cubic shape as the stereoscopic icon, however, other icons having any other shapes, e.g., sphere, ellipsoid, cylinder, polyhedral shapes (including but not limited to a cuboid, a pyramid, and a regular octahedron) may be displayed.

In the embodiment, the operation of pressing the icon is recognized based on the strength of the detected pressure, however, the operation of pressing the icon may be recognized based on the length of time of a touch. Specifically, when, after the operation of pinching the icon is recognized, if the touch with the finger on the touch panel 2 and the touch with the finger on the touch sensor 4 are continuously detected over a predetermined period without movements in the positions of touch points, the mobile phone terminal 31 recognizes that the operation of pressing the icon is performed. As explained above, the way to recognize the operation of pressing the icon based on the length of time of the touch is especially useful when a sensor, such as a capacitive type sensor, which is not sensitive to pressure, is used. Likewise, the pressing operation needs not be performed on a three-dimensional icon, and may be performed on a two-dimensional icon.

When the operation of pinching the icon is detected, the touch panel 2 or the like may be vibrated so as to give a tactile feedback to the user's finger(s). Any technology capable of giving tactile feedback can be used, for example, a technology achieved by vibrating a vibration portion at a specific frequency for a specific period as disclosed in Japanese Patent Application Laid-open No. 2010-146507 which is incorporated by reference herein in its entirety. By giving a tactile feedback to the fingers with which the icon is pinched, the user can naturally sense that the icon is pinched with his/her fingers. When thumbnail images or the like are displayed one by one according to the strength of the detected pressure, a tactile feedback may be given each time a new thumbnail image or the like is displayed according to the strength of the detected pressure. The control provided in this manner makes it easy for the user to adjust the pressure and cause a desired thumbnail image or the like to display.

In the embodiment, the icon having a cubic shape is stereoscopically displayed by using oblique projection or the like, however, binocular parallax may be used for stereoscopic display of the icon. In this case, a method of realizing stereovision with the naked eye is preferable to a method of requiring a device such as eyeglasses.

In the embodiment, a difference between movement distances of the two fingers upon rotation of the icon is not particularly limited. However, after recognition of the operation of pinching the icon, the movement distances of the fingers detected by the touch panel 2 and the touch sensor 4 may be adjusted to the smaller one of the movement distances, and converted to the rotation amount. Likewise, movement distances of the fingers detected by the touch panel 2 and the touch sensor 4 where the operation of pinching the icon is recognized may be adjusted to the greater one of the movement distances and converted to the rotation amount. It is comparatively difficult to perform intended operations on both the front and the back face of the mobile phone terminal 31, and therefore, when the operations are performed on the touch panel 2 and the touch sensor 4, an operation on one side can sometimes be unintentionally prolonged or shortened. By adjusting the movement distance to the smaller one, even if the intended operation cannot be performed in the above manner, an inadequate state can be prevented. In this case, a difference between the movement distances is processed as a movement distance for moving the position of the icon, so that the position of the icon may be moved by the difference between the movement distances.

In the embodiment, when the three-dimensionally shaped object is rotated, the direction of the object is changed. However, a function corresponding to a face of the object may be activated according to the direction in which the rotating operation is performed without changing the direction of the object. For example, in the case of Step S33 in FIG. 13, the program may be configured not to rotate the icon 40 so that the face with the star pictogram moves to the front face, but to activate the function corresponding to the face with the star pictogram without rotating the icon.

The aspects of the embodiments can be arbitrarily changed without departing from the spirit and the scope of the present invention. Moreover, the configurations represented in the embodiments can be combined with one other. For example, the screen control program 9C and the screen control program 39C may be separated into a plurality of modules, or may be integrated with other programs.

In the embodiments, the touch sensor 4 is provided on the face opposite to the face where the touch panel 2 is provided. However, the touch sensor 4 may be provided on any face if it is different from the face where the touch panel 2 is provided.

A touch panel (hereinafter, “touch panel X”), instead of the touch sensor 4, may be provided on a different face from the face where the touch panel 2 is provided. In this case, different faces of the same icon are displayed on the touch panel 2 and the touch panel X, respectively. When the icon on the touch panel X is tapped, the function corresponding to the face displayed as the front face on the touch panel X is activated. At this time, the screen provided by the activated function may be displayed on the touch panel 2 or may be displayed on the touch panel X. In addition, when the operation of pressing the icon is recognized, another object related to the function of the face displayed as the front face may be displayed on one of the touch panel 2 and the touch panel X on which the touch is first detected.

Here, the mobile electronic device provided with the touch panel 2 and the touch panel X may have a physically convertible housing. For example, the mobile electronic device provided with the touch panel 2 and the touch panel X may be a flip phone device in which a first housing provided with the touch panel 2 and a second housing provided with the touch panel X are coupled by a hinge. In this case, by folding the device so that the touch panel 2 and the touch panel X face each other, the device can be prevented from its malfunction caused by an inadvertent touch on the touch panel 2 and the touch panel X during transportation of the device. Moreover, by rotating the second housing about 360 degrees with respect to the first housing around the hinge as the axis of rotation, the mobile electronic device can be converted to a configuration in which the touch panel 2 is located on the front face of the device and the touch panel X is located on the back face thereof. Slider phones are another example of mobile electronic devices provided with a physically convertible housing.

The embodiments include at least the following subject matters.

(1) A mobile electronic device, comprising:

a housing having a first face and a second face different from the first face;

a first detector for detecting a first touch on the first face;

a second detector for detecting a second touch on the second face;

a display unit provided on the first face of the housing; and

a control unit for setting a selection range in an operation screen displayed on the display unit, based on a first position of the first touch detected on the first face and a second position of the second touch detected on the second face.

(2) The mobile electronic device according to (1), wherein the control unit is configured to

determine a third position on the first face which corresponds to the second position of the second touch detected on the second face; and

set the selection range based on the first position and the third position.

(3) The mobile electronic device according to (2), wherein

the control unit is configured to control the display unit to display a symbol indicating the third position on the operation screen.

(4) The mobile electronic device according to (1), wherein

the control unit is configured to change a display magnification of the operation screen displayed on the display unit in response to a movement of at least one of the first and second positions.

(5) The mobile electronic device according to (2), wherein the control unit is configured to change a display magnification of the operation screen displayed on the display unit in response to movements of at least one of the first and third positions according to a ratio between (i) a size of a rectangular area in which the first position and the third position before the movements are set as opposing corners and (ii) a size of a rectangular area in which the first position and the third position after the movements are set as opposing corners.
(6) The mobile electronic device according to (1), wherein

the control unit is configured to change a setting of the selection range in response to a movement of at least one of the first and second positions.

(7) The mobile electronic device according to (2), wherein the control unit is configured to select an object displayed inside a rectangular area in which the first position and the third position are set as opposing corners.
(8) The mobile electronic device according to (2), wherein the control unit is configured to select a text in a range in which one of the first position and the third position is set as a start point and the other is set as an end point.
(9) A mobile electronic device, comprising:

a housing having a first face and a second face different from the first face;

a first detector for detecting a first touch on the first face;

a second detector for detecting a second touch on the second face;

a display unit for displaying a three-dimensionally shaped first object, the display unit being provided on the first face of the housing; and

a control unit for changing, when the first object displayed on the display unit is on a line connecting a first position of the first touch detected on the first face and a second position of the second touch detected on the second face, a direction of the first object according to a movement direction and a movement distance of the first position and a movement direction and a movement distance of the second position.

(10) The mobile electronic device according to (9), wherein

the first object is a polyhedron having faces allocated with respective functions, and

the control unit is configured to activate, when a predetermined operation to the first object is detected by the first detector, the function allocated to a face displayed as a front face of the first object on the display unit.

(11) The mobile electronic device according to (9), wherein the control unit is configured to cause the display unit to display one or more second object related to the first object when

both the first touch on the first position and the second touch on the second position are detected over a predetermined period while the first object is displayed on the line connecting the first position and the second position, or

either one of a pressure detected by the first detector at the first touch and a pressure detected by the second detector at the second touch is greater than a predetermined magnitude while the first object is displayed on the line connecting the first position and the second position.

(12) The mobile electronic device according to (11), wherein the control unit is configured to change a number of the second objects to be displayed according to the magnitude of the pressure detected by the first detector or the second detector.
(13) The mobile electronic device according to (11), wherein the first object is a container object including the one or more second object as an element.
(14) The mobile electronic device according to (11), wherein

the first object corresponds to a function of processing electronic data,

each of the second objects corresponds to the data processed by the function at various points in time, and

the control unit is configured to cause the display unit to display the second objects in the order of the most recently processed second object being displayed first.

(15) The mobile electronic device according to (9), wherein the control unit is configured to rotate the first object according to the movement directions and the movement distances of the first position and the second position.
(16) The mobile electronic device according to (9), further comprising a vibrating portion,

wherein, the control unit is configured to cause, when the first object is displayed on the line connecting the first position and the second position, the vibrating portion to vibrate at least one of the first face and the second face.

(17) The mobile electronic device according to (9), wherein the control unit is configured to cause the display unit to stereoscopically display the first object.
(18) A mobile electronic device, comprising:

a housing having a first face and a second face different from the first face;

a first detector for detecting a first touch on the first face;

a second detector for detecting a second touch on the second face;

a display unit for displaying a first object, the display unit being provided on the first face of the housing; and

a control unit for changing, when the first object displayed on the display unit is between a first position of the first touch detected on the first face and a second position of the second touch detected on the second face, a direction of the first object according to a movement of at least one of the first position or the second position.

(19) A screen control method executed by a mobile electronic device that includes a housing, a first detector on a first face of the housing, a second detector on a second face of the housing different from the first face, and a display unit provided on the first face of the housing, the screen control method comprising:

displaying an operation screen on the display unit;

detecting a first touch on the first face by the first detector;

detecting a second touch on the second face by the second detector; and

setting a selection range in the operation screen displayed on the display unit based on a first position of the first touch detected on the first face and a second position of the second touch detected on the second face.

(20) A screen control method executed by a mobile electronic device that includes a housing, a first detector on a first face of the housing, a second detector on a second face of the housing different from the first face, and a display unit provided on the first face of the housing, the screen control method comprising:

displaying a first object on the display unit;

detecting a first touch on the first face by the first detector;

detecting a second touch on the second face by the second detector; and

changing, when the first object displayed on the display unit is between a first position of the first touch detected on the first face and a second position of the second touch detected on the second face, a direction of the first object according to a movement of at least one of the first position or the second position.

(21) A non-transitory storage medium that stores a screen control program for causing, when executed by a mobile electronic device which includes a housing, a first detector on a first face of the housing, a second detector on a second face of the housing different from the first face, and a display unit provided on the first face of the housing, the mobile electronic device to execute

displaying an operation screen on the display unit;

detecting a first touch on the first face;

detecting a second touch on the second face; and

setting a selection range in the operation screen displayed on the display unit based on a first position of the first touch detected on the first face and a second position of the second touch detected on the second face.

(22) A non-transitory storage medium that stores a screen control program for causing, when executed by a mobile electronic device which includes a housing, a first detector on a first face of the housing, a second detector on a second face of the housing different from the first face, and a display unit provided on the first face of the housing, the mobile electronic device to execute

displaying a first object on the display unit;

detecting a first touch on the first face;

detecting a second touch on the second face; and

changing, when the first object displayed on the display unit is between a first position of the first touch detected on the first face and a second position of the second touch detected on the second face, a direction of the first object according to a movement of at least one of the first position or the second position.

What is claimed is:

1. A mobile electronic device, comprising:
a housing having a first face and a second face different from the first face;
a first detector for detecting a first touch on the first face;
a second detector for detecting a second touch on the second face;
a display unit provided on the first face of the housing; and
a control unit for selecting an object displayed on the display unit, based on a first position of the first touch detected on the first face and a second position of the second touch detected on the second face.

2. The mobile electronic device according to claim 1, wherein the control unit is configured to
select the object based on the first position and a third position on the first face which corresponds to the second position of the second touch detected on the second face.

3. The mobile electronic device according to claim 1, wherein
the control unit is configured to control the display unit to display a symbol indicating a position on the first face which corresponds to the second position of the second touch detected on the second face.

4. The mobile electronic device according to claim 1, wherein
the control unit is configured to change a display magnification of the selected object in response to a movement of at least one of the first and second positions.

5. The mobile electronic device according to claim 1, wherein
the control unit is configured to select another object displayed on the display unit in response to a movement of at least one of the first and second positions.

6. The mobile electronic device according to claim 1, wherein the control unit is configured to
set a selection range for selecting the object, based on the first position and the second position; and
change a setting of the selection range in response to a movement of at least one of the first and second positions.

7. The mobile electronic device according to claim 2, wherein the control unit is configured to select the object displayed inside a rectangular area in which the first position and the third position are set as opposing corners.

8. The mobile electronic device according to claim 1, wherein the control unit is configured to select the object displayed between the first position and the second position.

9. The mobile electronic device according to claim 1, wherein the control unit is configured to
select a first object, based on the first position and the second position; and
transform the first object in response to a movement of at least one of the first and second positions.

10. The mobile electronic device according to claim 9, wherein
the control unit is configured to transform the first object so that one or more second object related to the first object is displayed on the display unit.

11. The mobile electronic device according to claim 1, wherein the control unit is configured to
select a first object, based on the first position and the second position; and
transform the first object when
both the first touch on the first position and the second touch on the second position are detected over a predetermined period while the first object is displayed between the first position and the second position, or
either one of a pressure detected by the first detector at the first touch and a pressure detected by the second detector at the second touch is greater than a predetermined magnitude while the first object is displayed between the first position and the second position.

12. The mobile electronic device according to claim 11, wherein the control unit is configured to transform the first object so that one or more second object related to the first object is displayed on the display unit.

13. The mobile electronic device according to claim 12, wherein
the first object corresponds to a function of processing electronic data,
each of the second objects corresponds to the data processed by the function at various points in time, and
the control unit is configured to cause the display unit to display the second objects in the order of the most recently processed second object being displayed first.

14. The mobile electronic device according to claim 1, wherein
the object is three-dimensionally shaped, and
the control unit is configured to change a direction of the object in response to a movement of at least one of the first and second positions.

15. The mobile electronic device according to claim 14, wherein
the object is a polyhedron having faces allocated with respective functions, and
the control unit is configured to activate, when a predetermined operation to the object is detected by the first detector, the function allocated to a face displayed as a front face of the object on the display unit.

16. The mobile electronic device according to claim 1, wherein the control unit is configured to rotate the object in response to a movement of at least one of the first and second positions.

17. The mobile electronic device according to claim 1, further comprising a vibrating portion,
wherein the control unit is configured to cause, when the object is displayed between the first position and the second position, the vibrating portion to vibrate at least one of the first face and the second face.

18. A screen control method executed by a mobile electronic device that includes a housing, a first detector on a first face of the housing, a second detector on a second face of the housing different from the first face, and a display unit provided on the first face of the housing, the screen control method comprising:
displaying an object on the display unit;
detecting a first touch on the first face by the first detector;
detecting a second touch on the second face by the second detector; and
selecting the object displayed on the display unit based on a first position of the first touch detected on the first face and a second position of the second touch detected on the second face.

19. A non-transitory storage medium that stores a screen control program for causing, when executed by a mobile electronic device which includes a housing, a first detector on a first face of the housing, a second detector on a second face of the housing different from the first face, and a display unit provided on the first face of the housing, the mobile electronic device to execute
displaying an object on the display unit;
detecting a first touch on the first face;
detecting a second touch on the second face; and
selecting the object displayed on the display unit based on a first position of the first touch detected on the first face and a second position of the second touch detected on the second face.
